(19) United States
(12) Patent Application Publication
(10) Pub. No.: US 2013/0154520 A1
(43) Pub. Date: Jun. 20, 2013

(54) ENERGY EFFICIENT LAMP

(71) Applicant: Avraham Emanuel, Johannesburg (ZA)

(72) Inventor: Avraham Emanuel, Johannesburg (ZA)

(73) Assignee: YEHI-OR LIGHT CREATION LTD., RaAnana (IL)

(21) Appl. No.: 13/818,694

(22) PCT Filed: Aug. 24, 2011
(86) PCT No.: PCT/IL11/00682

§ 371 Date: Feb. 25, 2013

Related U.S. Application Data
(60) Provisional application No. 61/376,271, filed on Aug. 24, 2010.

(30) Foreign Application Priority Data
Aug. 24, 2010 (US) 12/861854

(51) Int. Cl. H01J 17/14

(52) U.S. Cl. CPC H01J 17/14
USPC 315/338; 313/156; 313/443

(57) ABSTRACT

A lighting tube provides a path from the anode to the cathode in which the kinetic energy of the electrons is maintained substantially within the range of the excitation energies of visible photons, and in particular the excitation energies of yellow light. Magnets are arranged to provide a magnetic field that is substantially perpendicular to the electric field between anode and cathode. The orthogonal electrical and magnetic fields along the path are provided with values that accelerate the electrons but limit the maximum kinetic energy. Low pressure gas may be provided in the tube.

### FIELD AND BACKGROUND OF THE INVENTION

The present invention relates to an energy efficient lamp and, more particularly, but not exclusively to a lamp utilizing collisions of electrons with gas particles to generate photons.

Conventional lamps include incandescent lamps and discharge lamps of various kinds including fluorescent lamps. Incandescent lamps include a filament that gets heated to a temperature at which it glows brightly.

Discharge lamps typically comprise a glass tube filled with a suitable gas (or gases), with electrons being accelerated in such a way that part of their kinetic energy may be transferred to the molecules of the gas, thereby exciting electrons in them to suitable energy levels. The excited electrons then return to their original energy levels while giving out photons. This process is well known in quantum physics. Fluorescent lamps typically enhance the effect by using a coating on their outer walls to glow or fluoresce when struck by electrons or by ultra-violet radiation, so that additional, non-visible energy given out by the collisions may be converted into visible light and improve efficiency. More particularly, gas-discharge lamps are a family of artificial light sources that generate light by sending an electrical discharge through an ionized gas, i.e. a plasma. Typically, such lamps use a noble gas, such as argon, neon, krypton or xenon, or a mixture of these gases. Most lamps are filled with additional materials, mercury, sodium, and/or metal halides. In operation the gas is ionized, and free electrons, accelerated by the electrical field in the tube, collide with gas and metal atoms. Some electrons circling around the gas and metal atoms are excited by these collisions, bringing them to a higher energy state. When the electron falls back to its original state, it emits a photon, resulting in visible light or ultraviolet radiation. The ultraviolet radiation may then be converted to visible light by a fluorescent coating on the inside of the lamp's glass surface, as discussed above. The fluorescent lamp is perhaps the best known gas-discharge lamp.

Gas-discharge lamps offer long life and high light efficiency, but are more complicated than incandescent lamps to manufacture, and they require electronics to provide the correct current flow through the gas.

A downside with all of the above conventional lamps is their relatively low efficiencies. Incandescent lamps have efficiencies of 8% and even the most efficient fluorescent lamps rarely exceed 22%.

Another way of measuring efficiency is in lumens generated per Watt of electricity used. Standard tungsten incandescent lamps achieve around 15 lumens per Watt, whereas tungsten halogen lamps may achieve up to 30 lumens per Watt, and fluorescent lamps achieve a maximum of 100 lumens per Watt. High pressure sodium lamps manage 150 lumens per Watt, and low pressure sodium lamps are even more efficient, producing up to 200 lumens per Watt but the downside is that they provide very poor color rendering, and thus are mainly used as street lighting.

In all cases, a relatively high amount of energy is converted and dissipated as heat energy, which is clearly not ideal. In the various kinds of gas discharge lamps a large amount of energy is lost in ionizing gas particles during collisions and the majority of electrons do not reach the right energy to create excitation.

It is noted that the human eye is particularly sensitive to the color yellow, so that even if a particular lamp is not efficient overall, if it manages to produce a disproportionate amount of yellow then it is more efficient in terms of lumens/Watt.

A standard fluorescent tube has an electrical field of less than 1V per cm, under whose influence ions move from the anode to the cathode. The ions bombard the cathode, and many of the free electrons, which have low energies, collide with gas particles on the way to the anode so that no photons are created. The ionisation of gas particles is itself wasteful of energy. Overall there is little control of the electrons in their passage between anode and cathode.

### SUMMARY OF THE INVENTION

The present embodiments may provide a path from the cathode to the anode in which control may be exerted over the electrons so that the kinetic energy of the electrons is maintained substantially within the range of the excitation energies in order to efficiently create light in the desired spectrum

According to one aspect of the present invention there is provided a lighting tube having a first end and a second end, defining a longitudinal length therebetween, and comprising:
a field anode and a field cathode arranged lengthwise along the tube to provide an electric field;
magnets arranged lengthwise along the tube to provide a magnetic field, the magnets being arranged such that the magnetic field is substantially perpendicular to the electric field;
the electric and magnetic fields together providing an electron path lengthwise along the tube, and the field anode and/or cathodes are provided as smooth transparent coatings on the glass of the tube, for example a coating of tin oxide.

Alternatively, at least one of the field anode and the field cathode is shaped to comprise non-uniformities.

In an embodiment, the field cathode comprises the shaping to provide non-uniformities.

In an embodiment, the magnetic field is substantially uniform.

In an embodiment, the magnets are arranged at regular intervals to provide the substantially uniform field.

In an embodiment, the regular intervals are of the order of magnitude of fifteen millimeters.

In an embodiment, the electric field is in the order of magnitude of 200 Volts per centimeter.

In an embodiment, the magnetic field is of a range lying within an order of magnitude of 300 Gauss to 1000 gauss.

An embodiment may comprise an emission cathode to provide electron emission for the path.

In an embodiment, the emission cathode is a hot cathode, and the field cathode is a cold cathode.

In an embodiment, at least one of the field anode and the field cathode comprises a mesh.

In an embodiment, the first and second ends are joined to provide a continuous path.

The lamp may be a low pressure tube, and may have pressures within the range of 2 Tor, 1 Tor and 0.5 Tor.

The lamp may be operated by direct current. The lamp may have a widthwise diameter, and wherein a ratio of the longitudinal length to the widthwise diameter is of the order of magnitude of 50:1 or greater.

According to a second embodiment of the present invention there is provided a lighting tube having a first and a second end and comprising:
a field anode and a field cathode arranged lengthwise along the tube to provide an electric field;
magnets arranged lengthwise along the tube to provide a magnetic field, the magnets being arranged such that the magnetic field is substantially perpendicular to the electric field;
the electric and magnetic fields together providing an electron path lengthwise along the tube;
the tube being a low pressure tube having a pressure not exceeding two Tor.

An emission cathode may provide electron emission for the path. The cathode may be part of an electron gun arrangement in which an electron flux which is accelerated into the tube by a grid. In an embodiment the electron gun is shielded and a plasma may then form within the gun.

In an embodiment, the emission cathode is a hot cathode. The emitted accelerated electrons which bring about plasma release further electrons from the gas molecules and thus increase the electron flux. In an embodiment, the emission cathode is separate from the field cathode.

In an embodiment, the first and second ends are joined to provide a continuous path.

The lighting tube may have a widthwise diameter, and a ratio of the longitudinal length to the widthwise diameter may be of the order of magnitude of 100:1.

According to a third aspect of the present invention there is provided a method of lighting comprising:
within a confined space having a longitudinal length:
providing a magnetic field which is substantially uniform,
providing an electrical field which is in one embodiment uniform and in an alternative embodiment comprises non-uniformities,
the electrical and magnetic fields being set up orthogonally to one another along the longitudinal length;
and placing an emission cathode at a location in the longitudinal length to provide electrons to travel along the longitudinal length under influence of the orthogonal fields.

The method may involve selecting values of the fields to limit electron kinetic energy to excitation energies of photons of a desired wavelength, thereby to provide efficient conversion of electron collisions to photons.

The method may comprise providing a current density at the emission cathode not exceeding 20 milliAmperes per square centimeter.

The method may comprise providing power to the emission cathode, which power does not exceed one member of the group of proportions of the total power provided to the lamp, the group consisting of: 50%, 40%, 35%, 30%, 25%, 20%, 15%, 10% and 5%.

Unless otherwise defined, all technical and scientific terms used herein have the same meaning as commonly understood by one of ordinary skill in the art to which this invention belongs. The materials, methods, and examples provided herein are illustrative only and not intended to be limiting.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified schematic diagram illustrating a light tube having crossed electrical and magnetic fields, according to the present embodiments;

FIG. 2 is a theoretical diagram showing the path of a typical electron in the crossed electrical and magnetic field;

FIG. 3A is a theoretical graph of velocity or kinetic energy over the electron path for a charged particle in the crossed electrical and magnetic fields of FIG. 1;

FIG. 3B is a theoretical graph of energy for a conventional discharge lamp;

FIG. 3C is a theoretical graph of energy for a lamp according to embodiments of the present invention;

FIG. 3D is a schematic diagram illustrating a split tube lamp providing an infinite electron path according to embodiments of the present invention;

FIG. 4 is a perspective view of a lamp built to provide an electron path of the kind shown in FIG. 1;

FIG. 5 is a simplified diagram showing end detail of the lamp of FIG. 4;

FIG. 6 is a simplified diagram illustrating a thermionic cathode for emitting electrons, a mesh field cathode and a field anode for maintaining the electrical field along the tube, and respective connectors;

FIG. 7 is a simplified diagram illustrating the parts of FIG. 6 assembled with magnets into a tube and to be sealed with a sealing cap, according to an embodiment of the present invention;

FIG. 8 is a simplified diagram showing a view from below the cathode, of the assembly of FIG. 7 according to an embodiment of the present invention;

FIG. 9 is a simplified diagram showing the assembly of FIG. 7 without the sealing cap and illustrating a component holder;

FIG. 10 is a simplified diagram illustrating the electrodes and magnets held together with the component holders, prior to insertion into the tube, according to an embodiment of the present invention;

FIG. 11 is a close up detail of one of the component holders of FIG. 10 holding the cathode, anode and magnets together;

FIG. 12 shows the assembly of FIG. 11 being inserted into a tube, the right hand magnet and the anode being removed for clarity;

FIG. 13 is a simplified diagram of a rectangular tube of a second embodiment of a lamp according to the present invention, wherein the rectangular tube accepts insertion of the anode and cathode and external mounting of the magnets;

FIG. 14 is a simplified diagram showing the rectangular tube of FIG. 13 with magnets mounted externally, all being fitted in an external round tube;

FIG. 15 is a simplified diagram showing the internal mounting of the anode and cathode within the rectangular tube and external mounting of the magnets using a component holder;

FIG. 16 is a simplified diagram illustrating a ring-shaped tube with lengthwise electrodes for a lamp according to a third embodiment of the present invention;

FIG. 17 is a simplified diagram illustrating a mesh cathode mounted on the ring shaped tube of FIG. 16 and showing electrical connections thereto;

FIG. 18 shows the casing for the ring shaped lamp of FIG. 16 with cover removed;

FIG. 19 illustrates the mounting of the anode and cathode in the ring of FIG. 16, using component holders;

FIG. 20 illustrates the anode and cathode mounted as in FIG. 19, with magnets added, the whole being inserted into the casing of FIG. 18;

FIG. 21 is a simplified diagram illustrating electrical connectors for the anode and cathode mounted for the ring-shaped tube;

FIG. 22 is a simplified diagram illustrating a split tube lamp according to the embodiment of FIG. 3D;

FIG. 23 is a simplified cut-away diagram showing how a split tube lamp may be constructed according to the present embodiments;

FIG. 24 is a further perspective view of the cut-away diagram of FIG. 23;

FIG. 25 is a perspective view of a split tube lamp according to the present embodiments, in which the split follows the plane of the paper;

FIG. 26 is a perspective view of the split tube lamp of FIG. 25 in which the split is viewed end on; and

FIG. 27 is a simplified diagram showing a variant electron gun for the light tube of FIG. 1.

### DESCRIPTION OF THE PREFERRED EMBODIMENTS

The present embodiments comprise a lamp made up of a tube, gas at low pressure and electric and magnetic fields at right angles to each other to accelerate particles in a controlled acceleration along the length of the tube. The controlled acceleration may keep the kinetic energy of the electrons at a level suitable for generation of photons in the visible and/or in the ultra violet ranges. Collisions of the particles thus generate photons, and so ionization, heat generation and the like are almost eliminated.

The electrical field may be designed to be slightly non-uniform so as to assist with acceleration of the particles.

The lamp design and construction may be made in such a way as to reduce, or even prevent, discharge and ionization during collision between particles within the lamp.

One of the ways in which discharge and ionization may be avoided is to structure the emission cathode such that the current density of emitted electrons is less than 200 mA per square centimeter. Furthermore the emission cathode may be structured and powered in such a way so that it will consume less than 50% of the total lamp power. More particularly the emission cathode may consume less than 40%, or less than 35%, or less than 30%, or less than 25%, or less than 20%, or less than 15%, or less than 10% or less than 5% of the total lamp energy, in each case producing more efficient lighting.

A point about the current density at the emission cathode is that higher current densities tend to lead to electron clouds developing over the cathode, which then inhibit emission of further electrons. Lower current densities avoid cloud formation and the electrons behave as individuals, thus making the process more efficient.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

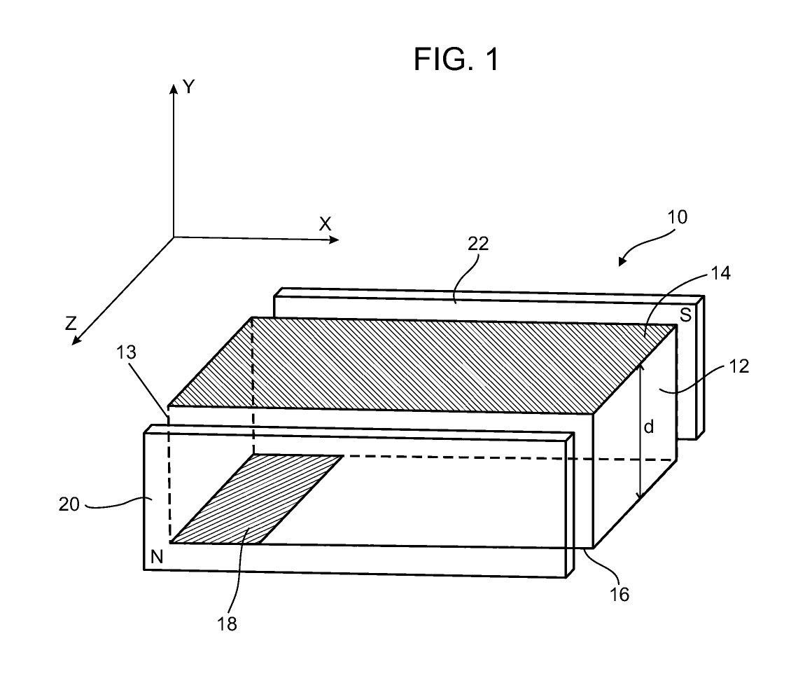

Reference is now made to FIG. 1 which is a generalized diagram illustrating a section of a lighting tube 10 having a first end 12 and a second end 13. A field anode 14, and a field cathode 16 are arranged lengthwise along the tube to provide an electric field.

Magnets 20 and 22 are arranged lengthwise along the tube to provide a magnetic field, and the magnets are arranged in relation to the anode and cathode so that the resulting magnetic field is substantially orthogonal to the magnetic field.

The electric and magnetic fields together may provide an electron path which spirals lengthwise along the tube, as will be described in greater detail below. The electron path spirals along the X dimension in the figure and is set up so that electrons emitted at one end of the tube may travel along the electron path to the far end of the tube.

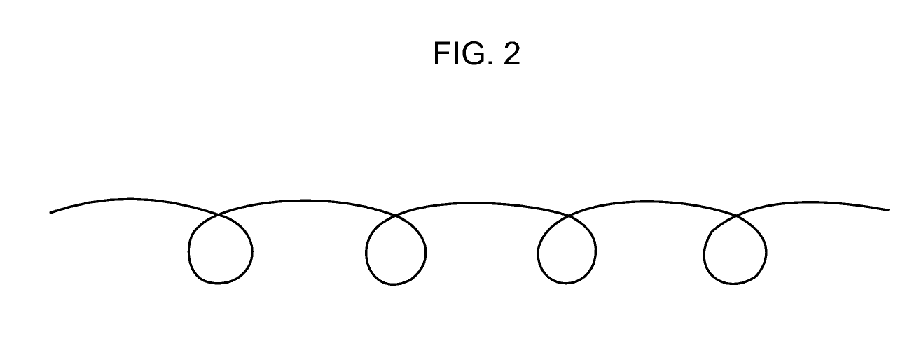

Reference is now made to FIG. 2, which is a theoretical diagram illustrating the typical path that electrons are understood to follow when placed in orthogonal electrical and magnetic fields inside a tube. The electrons spiral over the path, cycling between low speed states when the electrical field accelerates them radially towards the anode, and high speed states when the magnetic field pulls the accelerating electrons along the length of the tube. As the magnetic field pulls the electrons away from the anode the acceleration due to the electrical field is reduced and the level of kinetic energy in the electron can be controlled.

The idea of such an electron path is to control the passage of electrons in such a way as to ensure that any electron may provide, not as many collisions as possible as per standard electron discharge lamps but rather will produce as many photons as possible. To this end electrodes and a strong electrical field are provided perpendicularly to the strong magnetic field. The spiral path ensures that the speed and energy of the electrons remains reasonably steady in the absence of collisions with gas particles, as explained. If the electron does not collide with any other particle then it will travel the full length of the tube and retain energy. If there is a low energy collision say with a non-charged gas particle in the tube then there is an elastic collision and virtually no loss of energy. But if the collision hands over energy then a photon is emitted and the electron reduces its energy. A magnetic field ceases to have any affect on the electron since there is no motion, and instead, the electrical field starts to accelerate the electron upwards towards the anode of the tube. As the electron accelerates, the magnetic field begins to take effect again and the electron is pulled into the longitudinal direction of the tube. The electron soon returns to energy levels where it can emit a photon.

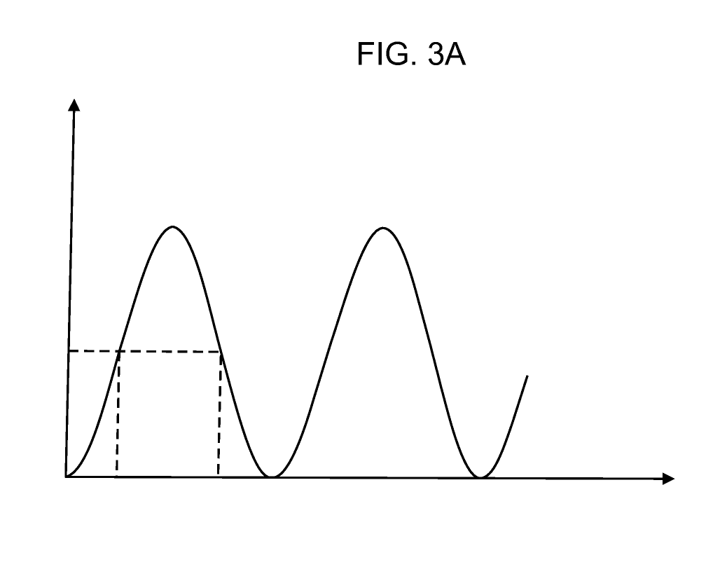

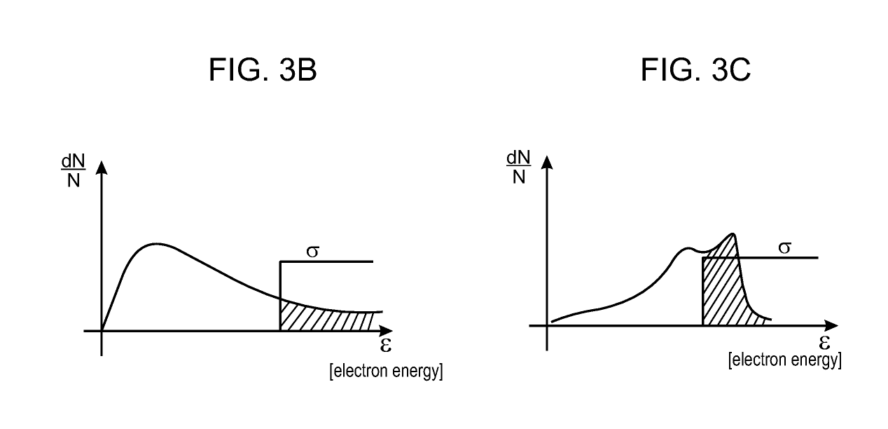

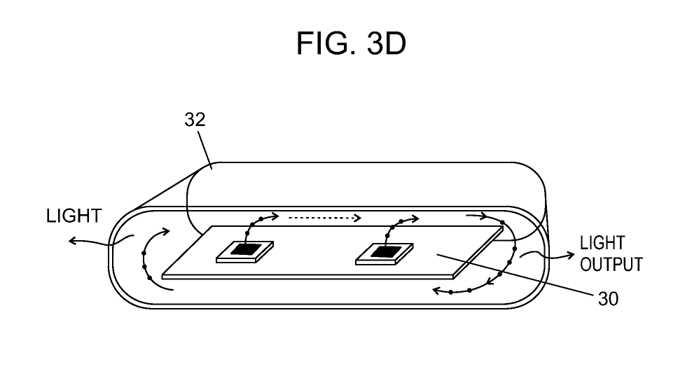

Reference is now made to FIG. 3A which is a simplified graph showing velocity or kinetic energy levels of the electron in the electron path in the absence of collisions. The velocity or kinetic energy may cycle between a maximum and zero.

Returning now to FIG. 1 and one or other of the field anode 14 and the field cathode 16 may be provided as a mesh, rather than a solid. The use of a mesh has two effects, firstly that the electrical field is non-uniform, which helps to accelerate the particles, and secondly that light generated is able to leave the tube. In one embodiment the field cathode is made into a mesh and the anode may be reflective. In another embodiment, both anode and cathode, or just the anode, may be made of a mesh.

The magnetic field may be substantially uniform, for example as a result of placing magnets at regular intervals, and the electric field may be substantially non-uniform due to the mesh as explained.

For example, magnets may be placed at regular intervals of the order of magnitude of fifteen millimeters to give a field of 300 Gauss. The electric field may be in the order of magnitude of 200 Volts per centimeter.

In FIG. 1, an emission cathode 18 provides electron emission. The emission cathode may be separate from the field cathode and may provide what is substantially point emission of electrons into the space of the tube. Typically the emission cathode is a hot cathode.

The hot emitting cathode may be kept at 800 to 1000 degrees depending on the material of the cathode. Tungsten would be hotter than this. A preferred material is beryllium oxide which is a good emitter of electrons at about 1000 degrees, and can be heated to this temperature more efficiently than other materials. Typically the skilled person will choose a material for the cathode that uses the least energy overall and emits a suitable quantity of electrons.

The cathode may provide a point discharge. This contrasts with existing lamps, which discharge over an entire area. Avalanche discharge, as found in conventional lamps, wastes energy on ionization, and on creating electrons which have random energies not suitable for light creation, i.e. their energy distribution is uncontrolled and therefore they make a low contribution to light. Indeed they mainly create heat. As explained herein, the present embodiments do not multiply the number of charged particles in the system and the number of electrons emitted is essentially the number accepted by the anode. Initially more electrons may be accepted due to electron clouds present in the gas, but eventually an equilibrium state is reached.

The above statement may be best understood by examining the energy distribution of the conventional discharge lamp vs. the lamp of the present embodiments. The energy distribution of a discharge lamp may be depicted as in FIG. 3B. The ‘step function’ denoted by σ is an idealized excitation by collision cross section function, and the overlap between the two is an indication of photon formation. As can be seen only a relatively small part (the tail) of the energy distribution function overlaps the σ function, giving relatively little photon formation. FIG. 3C shows the expected energy distribution of a lamp according to the present embodiments. The overlap in the case of FIG. 3C is clearly much larger and therefore the probability of excitation and expected efficiency are greater.

It is noted that in the case of the random motion of electrons, which corresponds to FIG. 3B, any electron undergoing loss of excitation energy during random collisions with gas molecules loses about 37% of the energy invested in it by the electric field. Often the collisions do not generate a photon and thus the energy is lost to the system. The present embodiments seek to ensure that the range of collisions are reduced to either those producing a photon or those which are purely elastic, so that substantially all the losses of excitation energy go directly into photon production.

A favorable energy distribution, which reduces the range of collisions to those either producing a photon or being fully elastic is understood to be due to the magnetic field which applies forces on the moving electrons in a strong electric field, thus limiting and controlling the maximum energies that the electrons may attain, as will be explained in greater detail below.

In FIGS. 3B and 3C:
dN=number of electrons between ε and ε+dε
N=total number of electrons within the tube at any given time.

The thermionic cathode which is responsible for the emission of electrons may have a relatively large enough area, so that the electron emission density is not large. A low electron density, as compared to conventional discharge type lamps, may allow the electrons to flow into the tube and perform motion as described in respect of FIGS. 2 and 3A.

The thermionic cathode is the main limitation on lifetime of the tube. In general a lifetime of between 20,000 and 100,000 hours can be selected by choosing the quantity of material on the cathode.

The tube may be a low pressure tube so that the collisions are controlled and collision multiplication does not occur. Collision multiplication causes ionization to occur without any corresponding production of photons and thus reduces the efficiency of the lamp. Generally, gas discharge lamps operate at around 5 Tor. The present lamp may operate below 2 Tor, even more efficiently at below 1 Tor and a greater level of efficiency is found at 0.5 Tor.

The tube may be operated by direct current (DC).

An efficient ratio of longitudinal length to widthwise radius is of the order of magnitude of 100:1. In an example the ratio is substantially 100:1. Higher ratios are possible but require stronger magnets. The electrodes may be longitudinal with a ratio of more than 20:1.

The rule of the length width relation may be due to the arc that the electron describes which has a relationship of π between length and breadth. In general, about 100 arcs may be needed for creation of one photon.

For a desired tube length of 60 cm, an anode cathode (emission cathode) distance of around 0.6 cm may be used. For 40 cm a distance of about 0.4 cm may be used.

For a tube length of 10 cm the distance between anode and cathode would be too small for a practical lamp.

The above ratio applies to a straight tube.

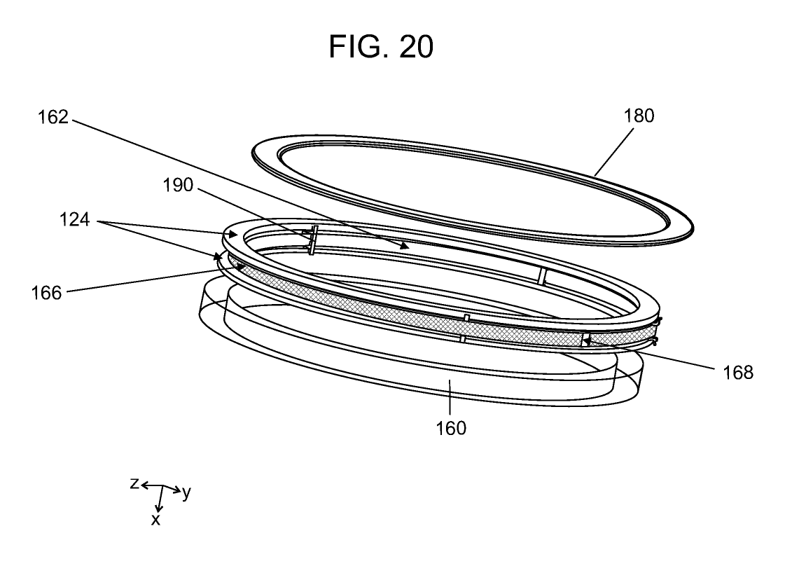

Reference is made to FIG. 3D which shows how a tube may be constructed in such a way as to create an endless electron path, thus eliminating tube length requirements, and enabling the achievement of maximum efficiency at almost any light spectrum and lamp size desirable. The tube may be, a split tube whereby the cathode or the anode is located along the center of the tube as indicated by reference numeral 30 and surrounded by the other electrode 32, so that the electron moves along and around the center electrode 30 in an endless loop. Other shapes such as a ring shape, an oval or the like are possible and a ring shape is discussed below in respect of FIG. 20.

In essence the tube becomes an endless track with point electron emission at one or more points, as will be described in greater detail hereinbelow.

As explained, the presently described lamp construction aims to provide improved control of the passage of electrons within the lamp. A passage along the entire length of the tube is provided. A specific emission cathode or thermionic cathode 18 is provided as the source of electrons but an additional field cathode 16 extends along the length of the tube to maintain an electric field against corresponding field anode 14.

The electron path may ensure that any electron may provide as many photons as possible. The electrodes along the length of the tube provide a relatively strong electrical field, in the order of magnitude of 200V per cm, as opposed to 1V per cm in the typical discharge lamp. Magnets provide a relatively strong magnetic field, in the order of 300 Gauss, which is at right angles to the electric field. The magnets may be placed outside of the gas-filled part of the lamp structure. The two fields between them define a spiral path for the electrons between collisions and the speed—energy relationship of the individual electrons is kept steady.

If the electron does not collide with a gas particle it may travel the full length of the tube and retain its energy. If a low energy collision with a gas particle occurs then the collision is elastic and effectively no loss of energy occurs, as explained above.

However, if the collision hands over energy then a photon is produced and the particle momentarily slows down. The magnetic field ceases to have any affect on the now-stationary particle but the electrical field starts to accelerate it and the particle moves along the electric field lines towards the outer wall of the tube. As the particle accelerates, the magnetic field starts to have greater effect, imparting an acceleration along the length of the tube.

For a tube of finite length energy efficiency was found to depend on the relationship between length and breadth of the tube, with a best energy output at a length to breadth ratio of about 100:1.

For a tube of infinite length—that is to say a ring-type tube, no equivalent width length relationship was found.

In typical gas discharge lamps, gas pressures of around 5 Tor are typical. However the present embodiments may use significantly lower gas pressures, the range of 0.5 to 1 Tor being typical. Higher pressures are possible but may in some circumstances require impractically thin lamps. One constraint on the width is the need to provide a sufficiently high magnetic field. The greater the width the larger the magnets needed to provide a given magnetic field.

Referring again to FIG. 1, a longitudinal high efficiency non-discharge gas filled lamp 10 according to the present embodiments may comprise a tube 12 filled with a gas or combination of gases. The gas may comprise for example Neon, or Argon, and even metal vapors such as Sodium or Mercury, or any other vapors.

It will be appreciated that the tube 12 can be in different shapes and sizes, although improved efficiency is achieved using the ratios discussed above.

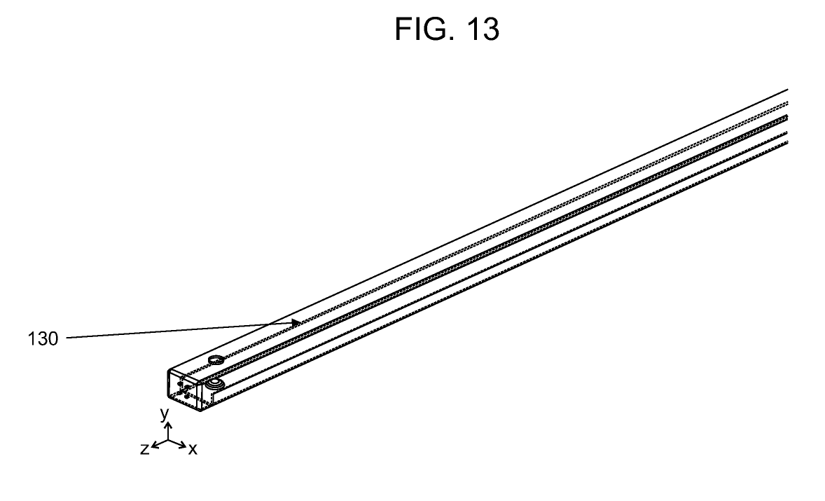

The field and emission cathodes 16, and 18 respectively, may be spaced apart from the anode 14, typically by placing them on opposite faces of the tube. The field cathode 16, which as explained may be provided as a mesh, may be placed outside the gas filled part of the lamp construction, either within or outside the glass walls of the tube. The same applies to the field anode and to the magnets. An embodiment with magnets external to the gas filled part but within outer glass walls is illustrated hereinbelow in FIGS. 13-15.

The electric field may be generated by applying either a DC or AC voltage across the anode 14 and cathodes 16, 18 so that there is an electric field of mean strength (V/a) in the y direction, where ‘a’ is the distance between the anode 14 and the cathode 16, 18.

A pair of opposed magnets may define a magnetic North 20 and a magnetic

South 22, thus providing a magnetic field across the tube 12. As can be seen in FIG. 1, the direction of the magnetic field is substantially perpendicular to the direction of the electric field, along the z direction.

A ratio between the electric and magnetic fields may be defined according to the gas or combination of gases within the tube 12, and other parameters, as well as gas pressure, in such a way that ionization and discharge are substantially prevented and overall efficiency is improved. As mentioned above, ionization and discharge use energy within the lamp without necessarily providing photons. As will be explained, the controlled passage of the electron along the path ensures that the electron never reaches the energy levels needed for ionization or discharge, and thus substantially all collisions are either elastic and energy conserving, or they emit a photon.

An electron may be emitted from the emission cathode. The electron may become subject to the spatial non-uniform or uniform but periodic electric field which is set up in the tube. Once it begins to accelerate it becomes subject also to the magnetic field and curves into the lengthwise direction of the tube. Under the influence of the fields the electron may continuously gain kinetic energy until it reaches a maximum with the kinetic energy then being reduced to a minimum, as will be discussed in greater detail below.

FIG. 3 shows the acceleration deceleration cycle of the electron in the absence of collisions. The cycle repeats periodically until the electron strikes a particle of the gas. Provided certain condition are satisfied, the electron delivers to the gas particle an amount of energy that leads to a resultant excitation of electrons in the atom of the gas, causing emission of a photon. The electron may be rendered stationary or slowed down by the collision, but then begins to accelerate under influence of the electric field. Once it has sufficient motion it begins to be affected by the magnetic field and the cycle begins again.

The controlling of the motion of the free electrons in the tube 12 is based on the fact that the trajectories of any charged particles in an electromagnetic environment are dependent on the directions of the electric and magnetic fields, which, in the illustrated embodiment, are perpendicular to each other, and on the ratio of the two fields. In an example embodiment, the ratio of the two fields is such that the maximum kinetic energy that any free electron may acquire (in accordance with FIG. 3a) may be between 3 eV and 8 eV, or more particularly between 5 eV and 7 eV.

The kinetic energy of the free electrons in the tube 12 is limited by applying the magnetic field together with the spatial non-uniform periodic electric field at defined intensities and ratio. The limited kinetic energies together with the low pressure in the lamp substantially prevent ionization and discharge. Furthermore, the combined field does not allow the emitted electrons to proceed with their motion in a straight line towards the anode, but their trajectories spiral as shown in FIG. 2, being periodic in energy, with a displacement in the x direction.

As indicated in FIG. 2, the electron may move primarily along the x direction, but in the y direction it may not exceed a maximum height Ay. If the maximum energy of the electron is about 7 or 8 eV, then the maximum height of the electron short of the anode 14. In short the electron does not reach the anode 14 unless it reaches an excitation level of about V/3 eV where V is the anode cathode voltage.

At the end of the path, where the magnetic field ends, the electron may then impact the anode, but with only an energy of the order of 3 eV so that sputtering is avoided, thus prolonging the tube's life.

The collisions are now considered in greater detail. When striking a gas particle, the electron may slow down and be diverted. If the kinetic energy of the electron is less than the minimal excitation energy of the gas molecules, the collision is elastic. If the kinetic energy is higher then excitation energy is transferred to the gas particle and a photon is released. If the voltage between the anode 14 and cathode 16, 18 is chosen to be say 300 V and the excitation energy needed for photons in the visible range is 3 eV, it is in principle ignoring ‘elastic’ collision losses possible to create 100 photons from a single electron emitted by the cathode 18.

The longitudinal spiral path of the electrons may limit the energies of the free electrons to a certain maximum, which eliminates ionization and discharge and ensures that collisions are either elastic or have an excitation energy which is correct for producing a photon, as explained. This is in contrast to the conventional discharge lamps, in which the motion of the free electrons is random and without any limiting mechanism. Collisions with gas particles in these conventional lamps may be at any or all energy levels, thus exciting the particles randomly to various levels of excitation. Thus some collisions may produce visible light. Other collisions may produce ultra-violet light and yet others may cause ionization or discharge, without producing corresponding photons and others do not reach the required level for excitation. The electrons in these conventional lamps then impact the anode 14 at their random energy levels, and the higher energy impacts create heat and cause sputtering.

FIG. 1 as discussed above, shows a rectangular construction of the lamp.

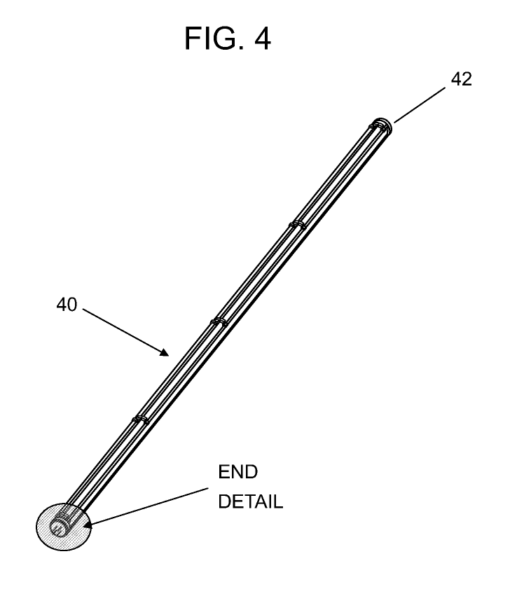

Reference is now made to FIG. 4, which is a perspective view of a lamp built to provide an electron path of the kind shown in FIG. 1. Tubular lamp 40 comprises a first end 42 which may house the emission cathode. The field anode and field cathode extend along the length of the tube at opposite sides to set up an electric field, and magnets are placed to set up a magnetic field at right angles to the electric field. An electron path is set up along the tube as explained.

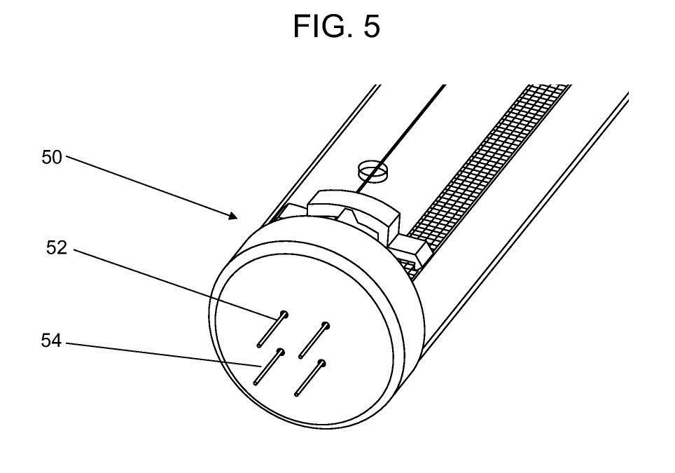

FIG. 5 shows an end view 50 of the lamp of FIG. 4. Electrical connections 52 provide positive DC voltage to the anode. Electrical connections 54 provide negative DC connections to the cathode.

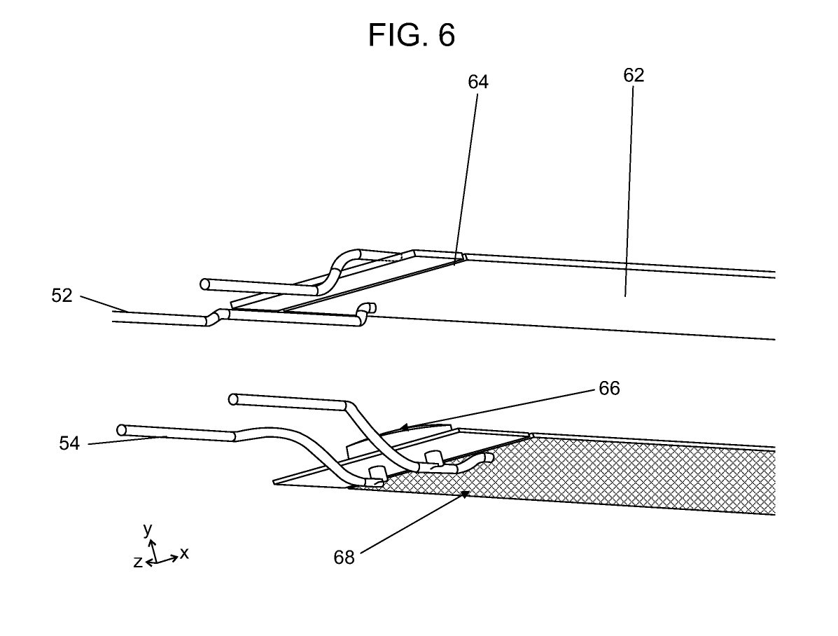

FIG. 6 is a cutaway view of the anode and cathode and showing the respective connections. Anode 62 may be split by divider 64 at about 5 mm from the end of the lamp to create a separate electric field above the thermionic cathode 66. Mesh cathode 68, along with thermionic cathode 66, is connected together to the negative voltage potential. The thermionic cathode 66 is further connected to a heating power supply.

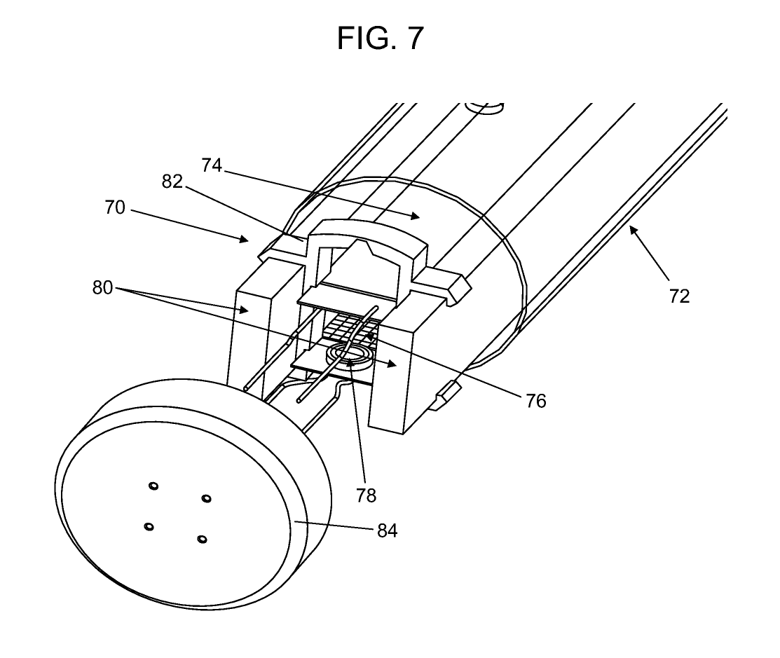

Reference is now made to FIG. 7 which shows an embodiment in which the lamp elements are inserted as a single unit assembly 70 into the tube 72. The unit assembly 72 includes field anode 74, mesh field cathode 76, emission cathode 78, and magnets 80, held together with component holder 82.

Following insertion the tube is sealed with sealing cap 84, evacuated of air and filled with a suitable gas.

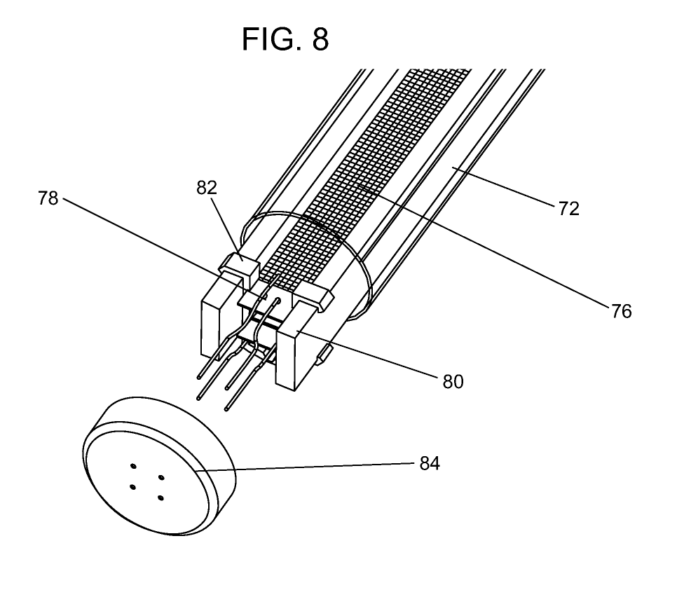

Reference is now made to FIG. 8 which is a view of the tube of FIG. 7 seen from the below the cathode. Parts are given the same reference numerals as in FIG. 7 and are not described again except as for understanding the present figure.

The mesh cathode allows light generated inside the tube to pass out of the tube. Light may pass both directly and by reflection through the mesh to provide illumination.

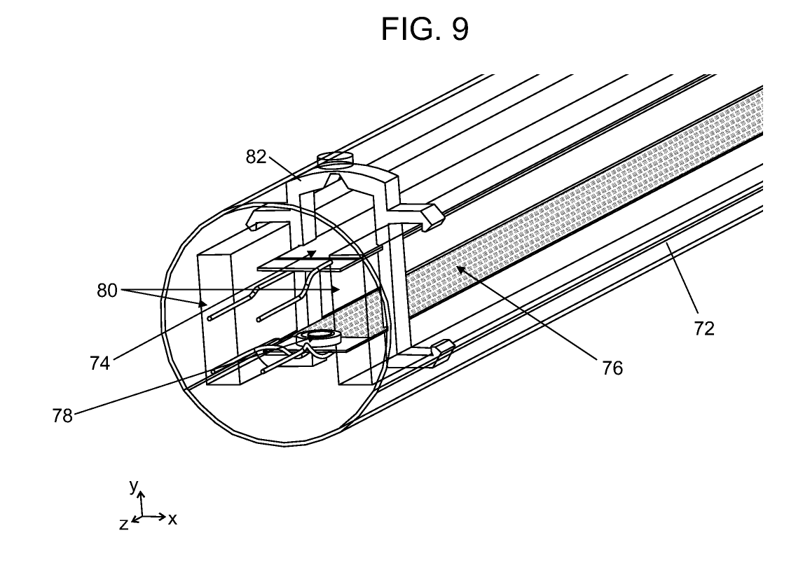

FIG. 9 is a simplified diagram showing the assembly of FIG. 7 without the sealing cap and held together within tube 72 by component holder 82.

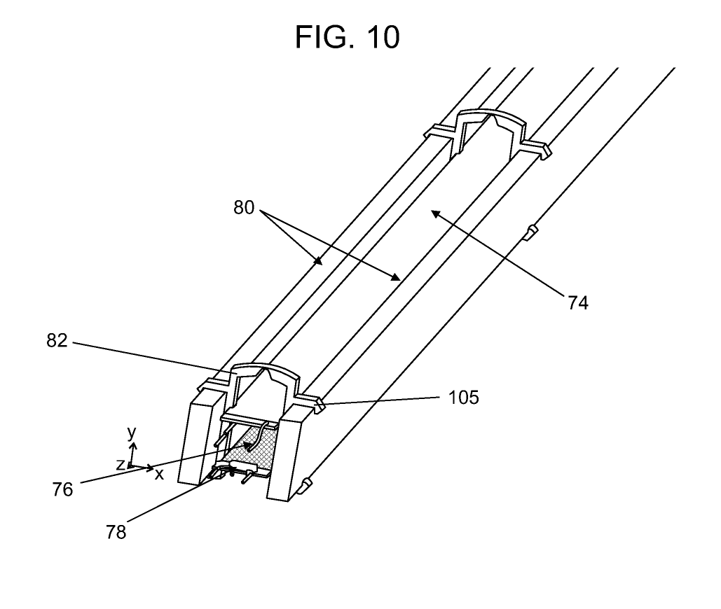

FIG. 10 shows a detail of the construction of the unit assembly 70. Component holders or connectors 82 grip the anode 74 and cathode 76 at a defined spacing. Extending arms 105 hold the magnets 80 firmly at opposite sides of the space defined between the anode and cathode.

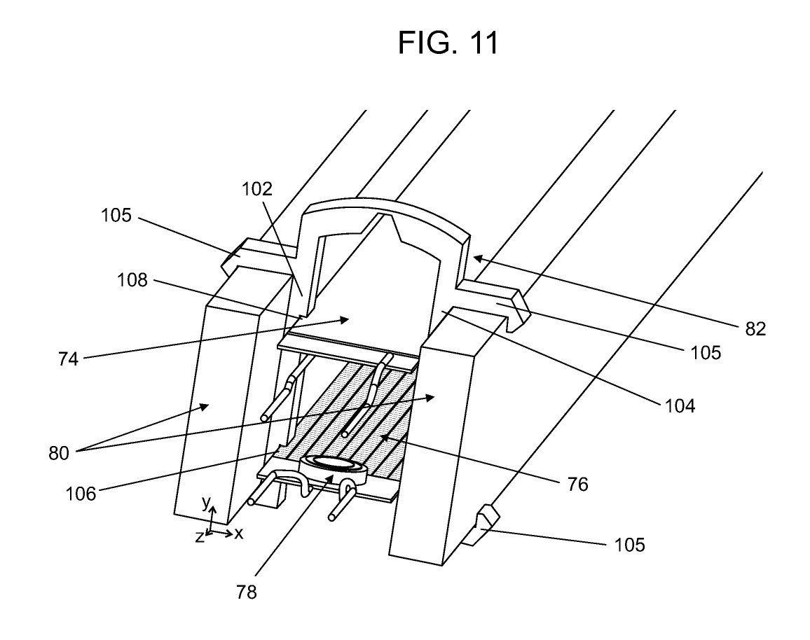

FIG. 11 shows one of the component holders 100 in greater detail. The two magnets 80 are attached to sides 102 and 104 respectively of holder 82 by gripping arms 105. The round thermionic cathode 78 and mesh field cathode 76 are attached in an indentation 106 towards the bottom of the holder. Anode 74 is attached to a corresponding indentation 108 at the holder top, in this specific example at a distance of 0.9 cm from the cathodes.

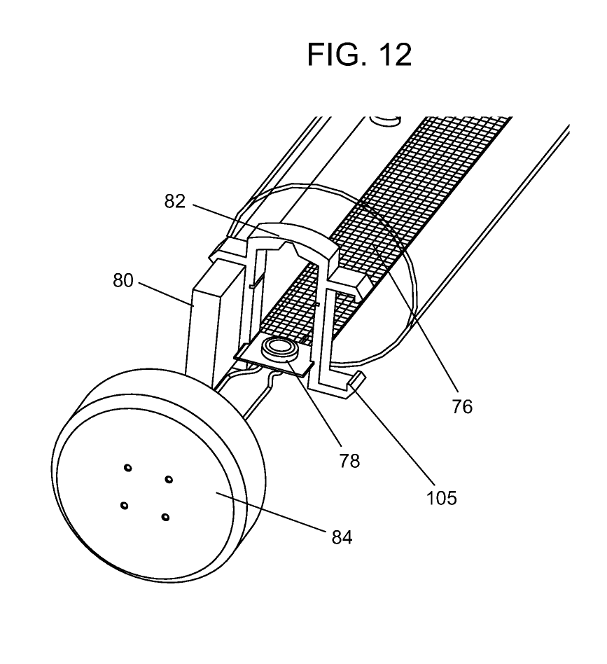

FIG. 12 shows the tube 72 with the unit assembly inserted and the anode and right hand magnets removed to show the mesh cathode from above. Light may pass out of the lamp via the mesh cathode.

Reference is now made to FIG. 13 which shows a rectangular shaped tube. More generally a parallelpiped may be considered.

Tube or parallelpiped 130 has a rectangular cross section and the anode and cathode are inserted therein. The tube is then filled with gas. In the embodiment of FIG. 13 magnets are mounted externally to the rectangular tube and the whole is fitted within an outer tube of round cross section, as will be explained below.

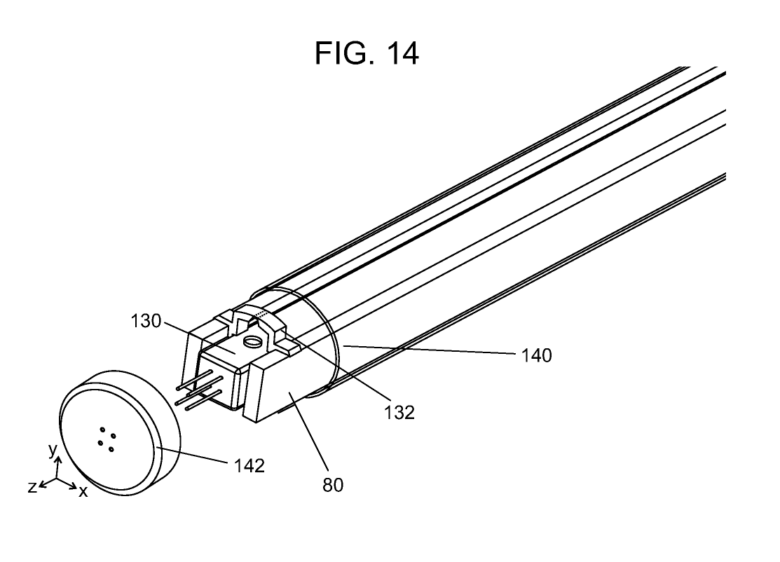

Moving to FIG. 14 and the magnets 80 are mounted around the tube 130 using holders 132. The whole is then placed within a second, circular tube 140 and sealed with a sealing cap 142.

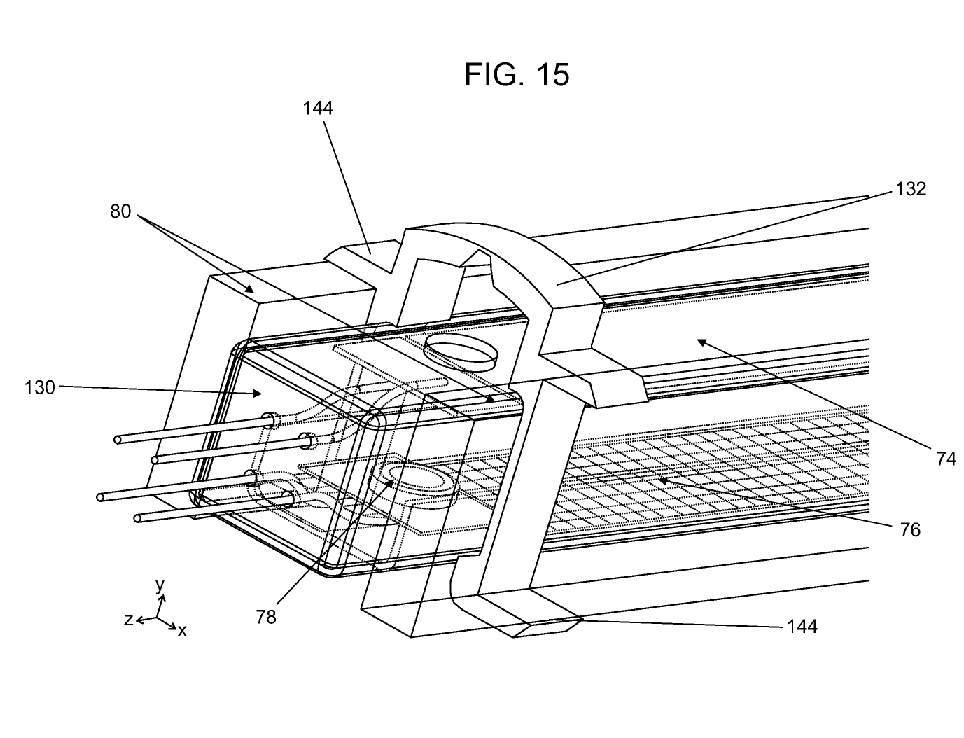

FIG. 15 shows the construction of FIG. 14 in greater detail. The anode 74 and field cathode 76 and thermionic cathode 78 are shown in situ within the rectangular tube 130. Holder 132 is mounted externally of the tube and fits snugly thereon. Magnets 80 fit on either side into arms 144 of the holder 132.

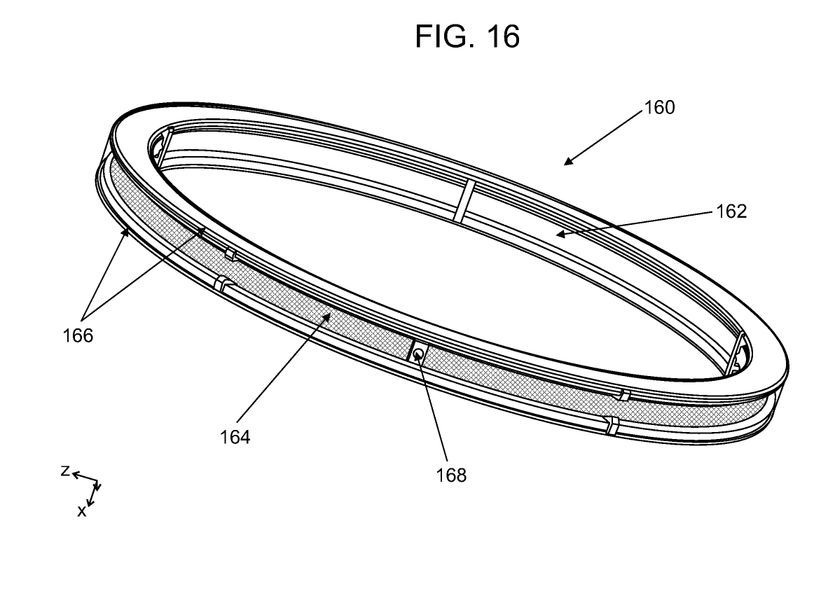

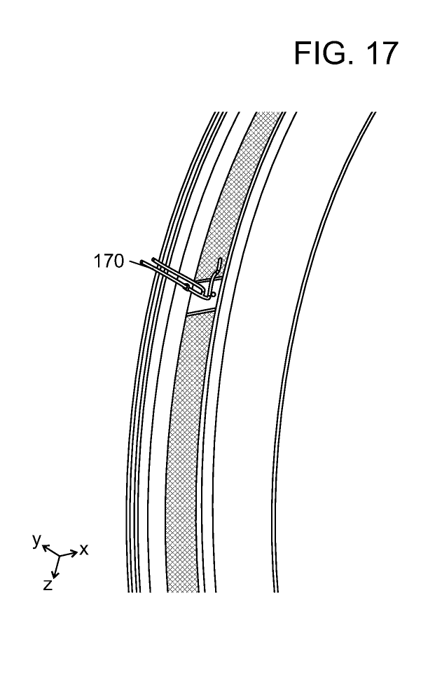

Reference is now made to FIG. 16, which shows a ring shaped tube 160 in a further embodiment of the present invention. The field anode and field cathode are ring shaped tracks 162 and 164 respectively, and magnets 166 are provided which describe a segment of the circumference of a circle. An emission cathode 168 may be placed at an arbitrary location on the ring to provide point emission of electrons which may then travel around the tube in an infinite path. Additional emission cathodes may be added at other locations on the ring if required.

FIG. 17 is a simplified diagram illustrating a mesh cathode mounted on the ring shaped tube 160 and showing electrical connections 170 to the cathode.

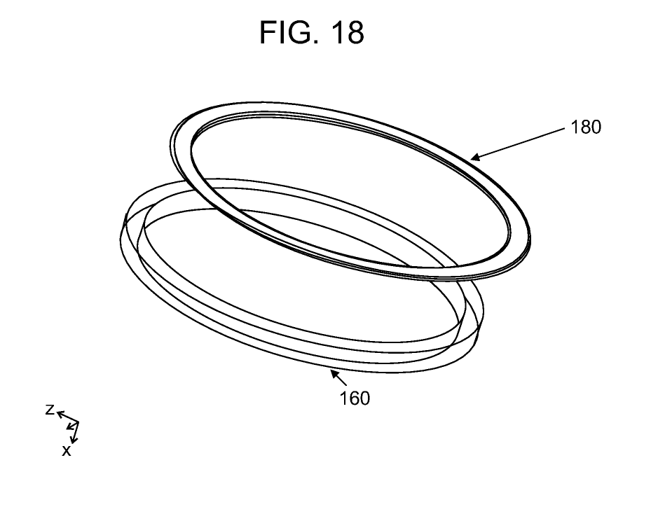

FIG. 18 shows the ring-shaped tube 160 with top cover 180 removed, into which the assembly including anode, cathode and magnets may be fitted as will be explained in reference to the following figures.

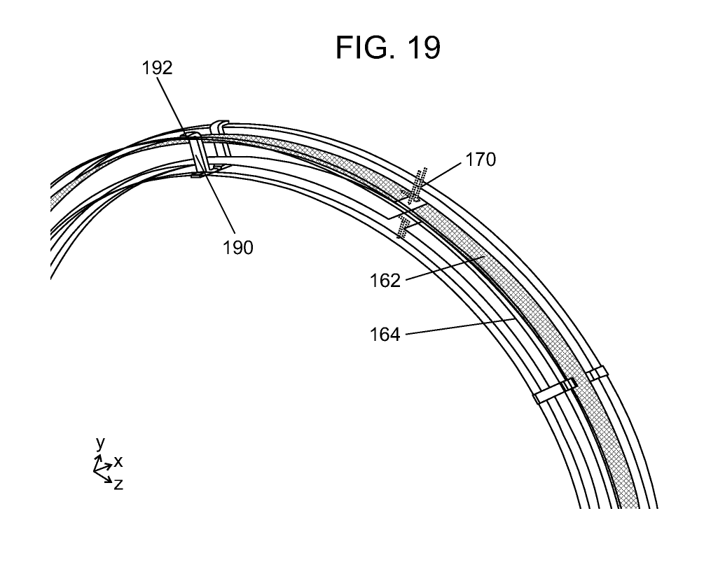

FIG. 19 shows the anode 162 and cathode 164 held together by holders 190.

Holders 190 include holder arms 192, and magnets may be fitted within holder arms 192 to form a ring-shaped assembly.

FIG. 20 is an exploded diagram of the elements, field anode 162, mesh field cathode 164, circular magnets 166 and electron emission cathode 168 being inserted into a glass tube 160 and cover 180 which may be sealed. The elements are held together by holders 190.

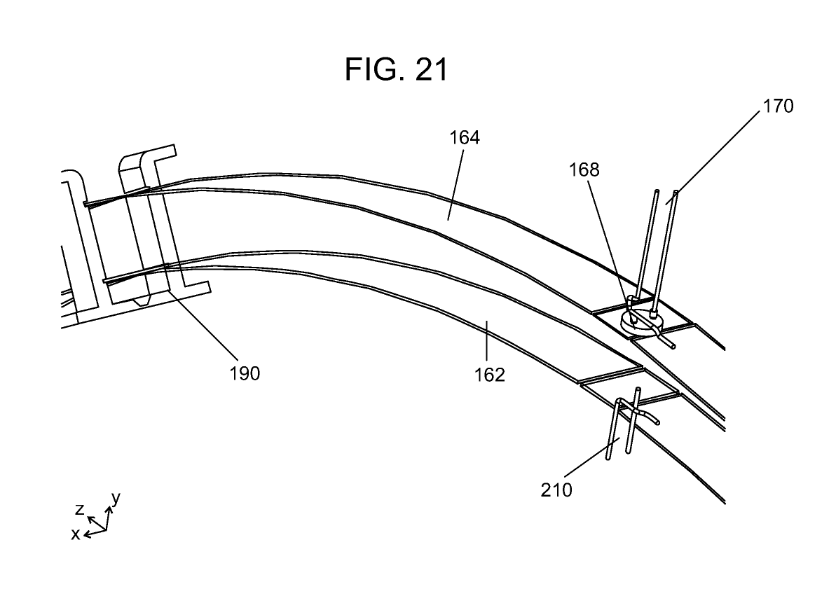

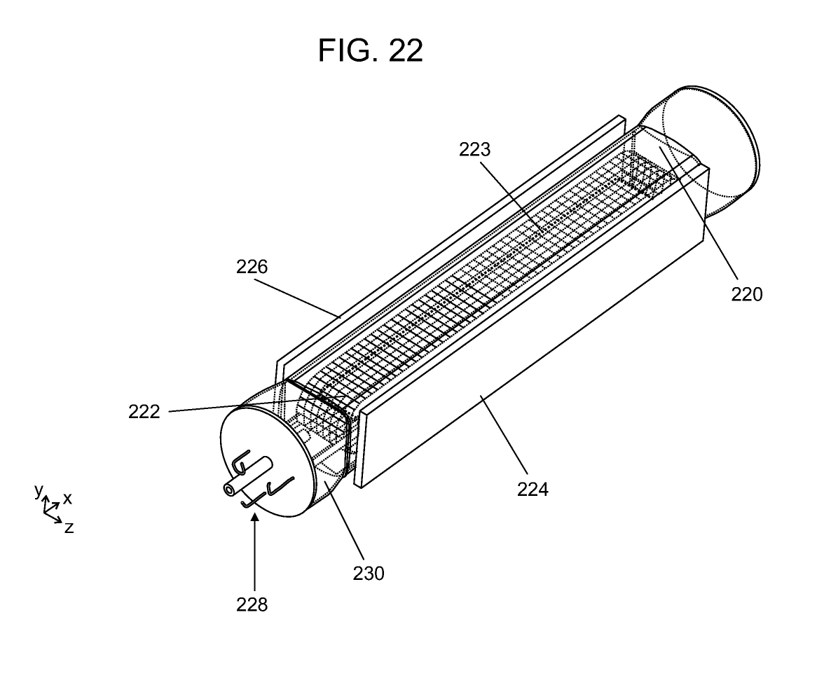

FIG. 21 shows holders 190 holding the anode 162, mesh field cathode 164 and emission cathode 168, and showing electrical connections 170 for the cathode and 210 for the anode.

A reflector may be fitted with the light, or incorporated as an inner face of the anode or magnets.

In one embodiment the magnets are transparent magnets made from iron particles embedded in glass.

The embodiments described above use permanent magnets and a DC supply for efficiency, but it is also possible to use electromagnets and an AC supply.

Reference is now made to FIG. 22, which is a simplified diagram illustrating a split tube lamp according to the embodiment of FIG. 3D. In FIG. 22 a glass tube 220 houses low pressure inert gasses on either side of a central divider 222. The central divider 222 divides the space within the glass tube into two chambers surrounded by a grid 223 which provides the electrical field. The central divider does not reach the ends of the tube so that the two chambers are joined at the end to form a single continual track for electrons. Magnets 224 and 226 on either side provide the perpendicular magnetic field. Electrical connections 228 are provided to the lamp from first end 230.

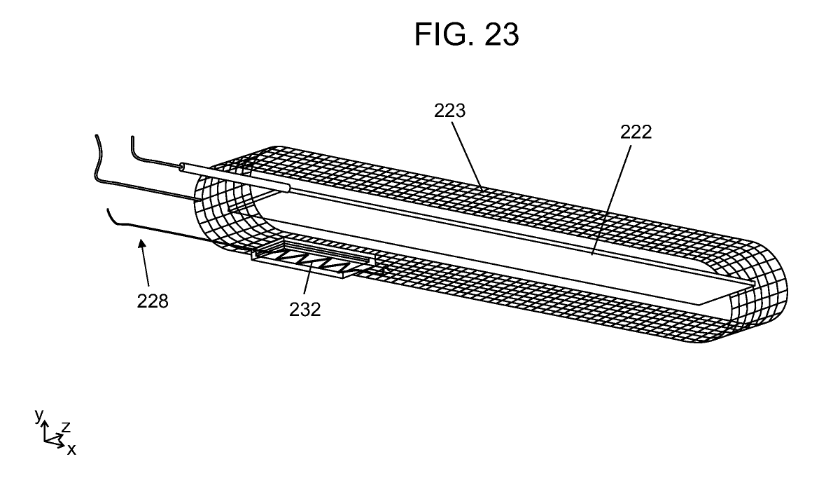

Reference is now made to FIG. 23, which is a simplified cut-away diagram showing how a split tube lamp may be constructed according to the present embodiments; The central divider 222 extends along a central axis and is surrounded by cathode grid 223. Emission cathode 232 fits within the cathode grid.

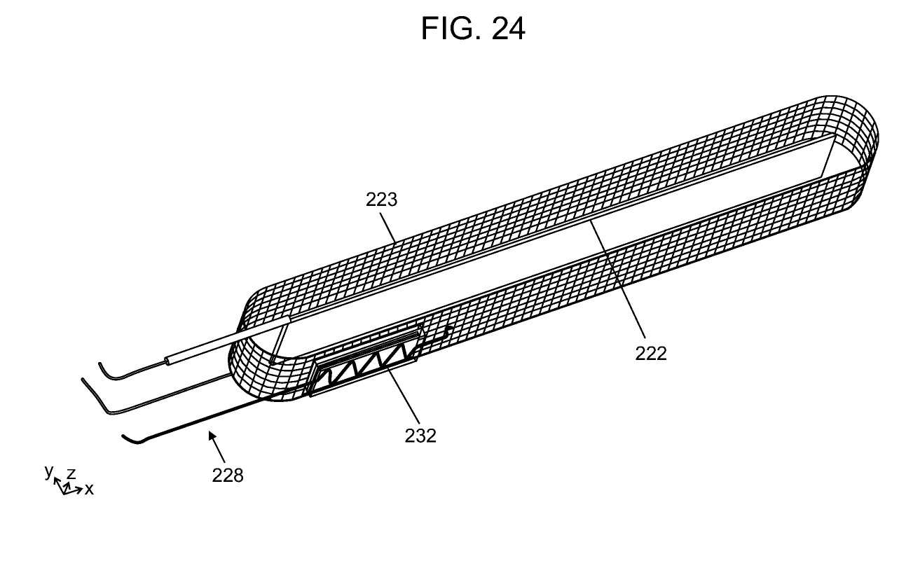

FIG. 24 is the same cut-away as in FIG. 23 but taken from a different perspective.

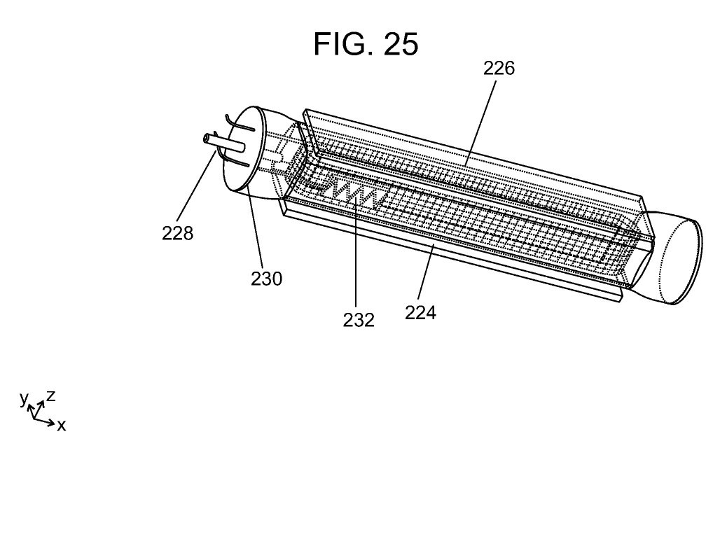

FIG. 25 is a perspective view of a split tube lamp according to the present embodiments, in which the split 222 follows the plane of the paper.

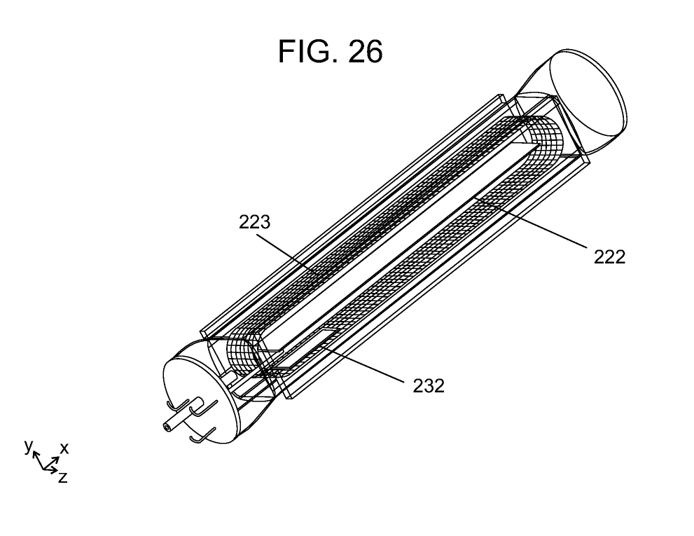

FIG. 26 is a perspective view of the split tube lamp of FIG. 25 in which the split 222 is viewed end on.

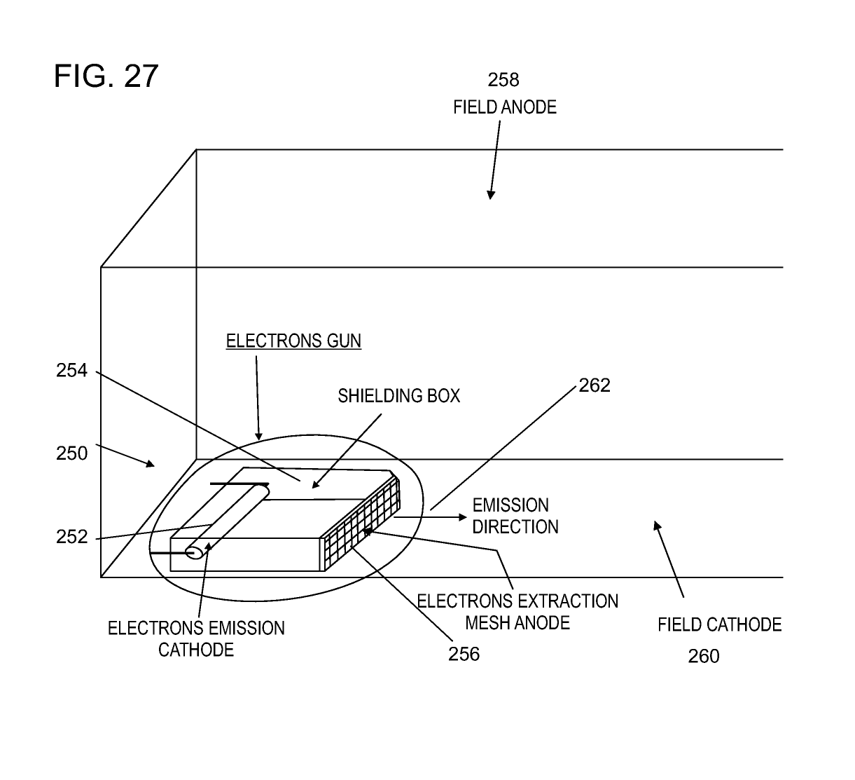

Reference is now made to FIG. 27, which is a simplified schematic diagram illustrating a modified electron gun 250 for the light tube of FIG. 1. An emission cathode 252 is placed within a shielding box 254 having an electron extraction mesh anode 256 which is positively charged to extract electrons from the cathode. In an embodiment the mesh is constructed of magnesium oxide MgO, which has the property of producing further electrons when struck. The mesh anode 256 may be a grid located between 10 and 30 mm of the cathode and at a positive voltage relative to the cathode. The grid is positioned with respect to the thermionic cathode to pull out electrons horizontally along the tube, and function as an electron gun. The electron gun works on the principle of local discharge.

The shielding 254 around the cathode enhances the electron flux and allows for local discharge. Without the shielding the current might be reduced due to the influence of the electromagnetic field.

Field anode 258 and field cathode 260 are at opposite sides of the tube as before and provide an electrical field which is orthogonal to a magnetic field. Electrons are emitted, through the grid, in the direction of arrow 262.

In a further modification to mitigate space charge effects, a transversely orientated cathode is provided or there are provided numerous separate cathodes having spaces between them across the width of the electron gun area. The space between them mitigates space charge effects and stops the emitted electrons from interfering with each other or inhibiting further electrons from being emitted.

The electron gun thus forms a pipe of between 10 and 30 mm, say typically 20 mm and brings about a plasma within the pipe. The hotter the cathode the stronger is the plasma. The grid at 256 located at the end of the pipe sucks out electrons from the plasma as a whole, with the effect that electrons form the gas are added to electrons to from cathode, thereby to increase the flux.

In an alternative embodiment, the shielding box may be omitted. In this case local discharge does not occur but the electrons which are emitted through thermionic emission from the cathode are still accelerated by the grid. When relying on thermionic emission the grid may be placed much nearer the cathode, say at a distance of between 0.5 mm and 2 mm.

A further modification is to use glass coated with tin oxide for the field cathode and the anode. A thin layer of tin oxide is transparent, so that unlike the mesh of the previous embodiments it does not interfere with the lighting effect. Although such a thin layer of tin oxide is somewhat resistive, the anode and field cathodes are not required to conduct, merely to provide an electric field. The mesh of the previous embodiments caused a non-uniform electric field. However the tin oxide coating is able to provide a uniform field.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A lighting tube having a first end and a second end, defining a longitudinal length therebetween, and comprising:
a field anode and a field cathode arranged lengthwise along said tube to provide an electric field;
magnets arranged lengthwise along said tube to provide a magnetic field, said magnets being arranged such that said magnetic field is substantially perpendicular to said electric field;
said electric and magnetic fields together providing an electron path lengthwise along said tube, and wherein at least one of said field anode and said field cathode comprises a smooth coating on the tube surface.

2. The lighting tube of claim 1, wherein said magnetic field is substantially uniform.

3. The lighting tube of claim 2, wherein said magnets are arranged at regular intervals to provide said substantially uniform field.

4. The lighting tube of claim 3, wherein said regular intervals are of the order of magnitude of fifteen millimeters.

5. The lighting tube of claim 1, wherein said electric field is in the order of magnitude of 200 Volts per centimeter.

6. The lighting tube of claim 1, wherein said magnetic field is of a range lying within an order of magnitude of 300 Gauss to 1000 gauss.

7. The lighting tube of claim 1, further comprising an emission cathode to provide electron emission for said path.

8. The lighting tube of claim 7, wherein said emission cathode comprises a plurality of discrete cathodes and intervening spaces across a width of said gun.

9. The lighting tube of claim 7, further comprising a grid in proximity to said emission cathode to accelerate electrons from said emission cathode.

10. The lighting tube of claim 9, wherein said grid comprises magnesium oxide.

11. The lighting tube of claim 9, further comprising shielding around said emission cathode.

12. The lighting tube of claim 7, wherein said emission cathode is a hot cathode, and said field cathode is a cold cathode.

13. The lighting tube of claim 1, wherein said smooth coating comprises a transparent layer of tin oxide.

14. The lighting tube of claim 1, wherein said first and second ends are joined to provide a continuous path.

15. The lighting tube of claim 1, being a low pressure tube.

16. The lighting tube of claim 15, having a pressure not exceeding one member of the group consisting of 2 Tor, 1 Tor and 0.5 Tor.

17. The lighting tube of claim 1, operated by direct current.

18. The lighting tube of claim 1, having a widthwise diameter, and wherein a ratio of said longitudinal length to said widthwise diameter is of the order of magnitude of 50:1 or greater.

19. A lighting tube having a first end and a second end, defining a longitudinal length therebetween, and comprising:
a field anode and a field cathode arranged lengthwise along said tube to provide an electric field;
magnets arranged lengthwise along said tube to provide a magnetic field, said magnets being arranged such that said magnetic field is substantially perpendicular to said electric field;
an electron gun comprising an emission cathode, and an electron acceleration grid positioned to accelerate electrons from said electron gun into an electron path lengthwise along said tube, the path defined by said electric and magnetic fields together.

20. The lighting tube of claim 19, further comprising shielding around said emission cathode.

21. The lighting tube of claim 19, wherein said emission cathode comprises a plurality of discrete cathodes and intervening spaces across a width of said gun.

22. A lighting tube having a first end and a second end, defining a longitudinal length therebetween, and comprising:
a field anode and a field cathode arranged lengthwise along said tube to provide an electric field;
magnets arranged lengthwise along said tube to provide a magnetic field, said magnets being arranged such that said magnetic field is substantially perpendicular to said electric field;
said electric and magnetic fields together providing an electron path lengthwise along said tube, and wherein at least one of said field anode and said field cathode is shaped to comprise non-uniformities.

23. The lighting tube of claim 22, wherein said field cathode comprises said shaping to provide non-uniformities.

24. A lighting tube having a first and a second end and comprising:
a field anode and a field cathode arranged lengthwise along said tube to provide an electric field;
magnets arranged lengthwise along said tube to provide a magnetic field, said magnets being arranged such that said magnetic field is substantially perpendicular to said electric field;
said electric and magnetic fields together providing an electron path lengthwise along said tube;
said tube being a low pressure tube having a pressure not exceeding two Tor.

25. The lighting tube of claim 24 having a pressure not exceeding one member of the group consisting of 1 Tor and 0.5 Tor.

26. The lighting tube of claim 24, further comprising an emission cathode to provide electron emission for said path.

27. The lighting tube of claim 26, wherein said emission cathode is a hot cathode.

28. The lighting tube of claim 26, wherein said emission cathode is separate from said field cathode.

29. The lighting tube of claim 24, wherein said first and second ends are joined to provide a continuous path.

30. The lighting tube of claim 24, having a widthwise diameter, and wherein a ratio of a longitudinal length of said tube to said widthwise diameter is of the order of magnitude of 100:1.

31. A method of lighting comprising:
within a confined space having a longitudinal length:
providing a low pressure not exceeding two Tor;
providing a magnetic field which is substantially uniform,
providing an electrical field,
said electrical and magnetic fields being set up orthogonally to one another along said longitudinal length;
and placing an emission cathode at a location in said longitudinal length to provide electrons to travel along said longitudinal length under influence of said orthogonal fields.

32. The method of claim 31, further comprising selecting values of said fields to limit electron kinetic energy to excitation energies of photons of a desired wavelength, thereby to provide efficient conversion of electron collisions to photons.

33. The method of claim 31, further comprising providing a current density at said emission cathode not exceeding 20 milliAmperes per square centimeter.

34. The method of claim 31, further comprising providing power to said emission cathode, which power does not exceed one member of the group of proportions of the total power provided to the lamp, the group consisting of: 50%, 40%, 35%, 30%, 25%, 20%, 15%, 10% and 5%.
